(19) United States
(12) Patent Application Publication
(10) Pub. No.: US 2024/0274832 A1
(43) Pub. Date: Aug. 15, 2024

(54) ELECTRODE AND BATTERY

(71) Applicant: MAX-PLANCK-GESELLSCHAFT ZUR FÖRDERUNG DER WISSENSCHAFTEN E.V., München (DE)

(72) Inventors: Timotheus JAHNKE, Stuttgart (DE); Yuanzhen WANG, Böblingen (DE); Maximilian HACKNER, Sparwiesen (DE); Joachim SPATZ, Stuttgart (DE)

(21) Appl. No.: 18/290,162

(22) PCT Filed: May 11, 2021
(86) PCT No.: PCT/EP2021/062443

§ 371 Date: Nov. 10, 2023

(51) Int. Cl. H01M 4/66; H01M 4/02; H01M 4/80

(52) U.S. Cl. CPC H01M 4/661; H01M 4/801; H01M 4/806; H01M 2004/021; H01M 2220/20

(57) ABSTRACT

The present invention relates to an electrode for a mono- or multivalent ion battery, comprising a three-dimensional network of metal fibers, wherein the metal fibers are directly in contact to one another, and an active material, wherein the network of metal fibers has a thickness in the range of 200 μm to 5 mm. Further, the present invention relates to a battery comprising the electrode of the present invention and to an electric vehicle, comprising the battery of the present invention.

The present invention concerns an electrode for a mono- or multivalent ion battery. Further, the present invention concerns a battery comprising such an electrode.

The need for large scale electrochemical energy storage devices is ever increasing with the current development for mobile applications, e.g. cars or other mobile gadgets.[1] One approach to increase the energy density of Lithium Ion Batteries (LIBs) as well as other monovalent and multivalent ion batteries is to increase the layer thickness of the electrodes, thus reducing the number of inactive components in a cell.[2-4] For LIBs substantial achievements, such as dry coating[5,6], sintering[7,8], and spray deposition[9] have already led to drastic improvements with regards to the electrodes thickness. However, an industrial electrode thickness is still limited to an area capacity of <4 mAh cm⁻², whereas a capacity of >10 mAh cm⁻² would be desired.[10,11]

Additionally, in order to increase the electrodes thickness, further investigation is still required with regards to the fundamental understanding of the processes taking place during the intercalation.[12,13] It is already known, that the sluggish ion diffusion kinetics and the poor rate performance are the main obstacles for thick electrodes.[4] The diffusion processes taking place in monovalent and multivalent ion batteries, in particular in LIBs, can be separated into intra- and intergranular solid diffusion and liquid diffusion between the particles and through the electrode.

Intragranular solid diffusion refers to the diffusion of Li ions in the active material itself, whereas intergranular diffusion is a diffusion occurring between the primary particles, i.e. inside the secondary particles.[12] Gao et al.[12] were able to demonstrate this effect in ultra-thick NMC (Ni—Mn—Co oxide) electrodes of LIBs by using Electrical Impedance Spectroscopy (EIS) and the Galvanostatic Intermittent Titration Technique (GITT). He and his coworkers showed, that a large decrease in the effective diffusivity occurs at electrodes with a thickness beyond 200 μm. This effect is related to the localized over depletion and oversaturation of Lithium, effecting the transport of Li in the electrolyte.[12] Hereby, the diffusivity in the liquid electrolyte is not large enough to supply a sufficient amount of ions to the intercalation sites, which is the cause for the over depletion or oversaturation.

Beyond this diffusion effect, the electrical conductivity of the active material layer is an additional limiting factor in the application of electrodes with an active material layer thickness beyond 200 μm. According to Zhang et al.[13], the electrical conductivity trough the active material layer towards the current collector and the electrical charge transfer at the interface between electrolyte and the active material should be sufficiently large. This charge transfer resistance is characterized by the transition of a solvated lithium ion in the electrode to an intercalated lithium atom, which subsequently is undergoing solid diffusion in the active material. The charge-transfer resistance can be reduced by fabrication of nanosized active materials, and consequently increasing the interface area between active material and electrolyte.[14] In order to overcome the electrochemical resistance associated with the electron transfer in the active material layer, conductive additives have been applied to decrease the ohmic drop.[15]

In conclusion, both high electrical conductivity and large ion diffusivity are required to fabricate ultra-thick electrodes with a thickness beyond 200 μm. Different approaches have been pursuit to overcome these challenges. For instance, freeze-drying of ultra-porous conductive electrodes leads to large areal capacities[15,16] and short diffusion paths[17]. However, their volumetric capacity still needs further improvements.

In order to unify both outstanding electrical conductivity and large ion diffusivity, a tailored composite material is required. A technique to fabricate such a composite material is to inherently enhance the diffusion of lithium ions in the electrolyte. A possible approach is to take advantage of the enhanced metal-metal surface diffusion. The physical principle behind the large increase in effective diffusivity is an enhanced ion flux along the metals surface, which could increase the effective diffusivity D_{eff} of the electrolyte. Several researches have investigated the lithium diffusion on planar copper surfaces. Bairav et al.[25] investigated terrace and interlayer surface diffusion of lithium deposited on metallic anodes, observed an ineligible influence of lithium surface diffusion on the dendrite formation. Rico Rupp's group [26] revealed the lithium ion surface diffusion along copper interface of the planar current collector in a lithium ion battery. Both studies could show that surface diffusion occurs on the current collector, but is not having an influence on the electrodes' performance. The lithium and lithium ion surface diffusion in LIB has a strong impact on the dendrite formation, lithium trapping on current collectors and SEI formation. However, it does not show any contribution to the diffusion flux in the electrolyte, due to the planar current collector, which is orthogonal to the ion flux.

In view of this, there is a need to provide ultrathick electrodes for a monovalent ion battery or a multivalent ion battery, in particular for a lithium ion battery, which has higher performance and life time.

According to the present invention, this object is solved by an electrode according to claim 1. In particular, this object is solved by an electrode for a mono- or multivalent ion battery, comprising a three-dimensional network of metal fibers, wherein the metal fibers are directly sintered to one another at points of contact between the metal fibers, and an active material, wherein the network of metal fibers has a thickness in the range of 200 μm to 5 mm.

The electrode of the present invention shows unexpected high diffusivity of mono- or multivalent ions, in particular of lithium ions. For example, the electrode of the present invention is capable of utilizing the beneficial surface diffusion effect of lithium on copper. Without being bound to a theory, in the electrode of the present invention a metal fiber-based sintered network acts as backbone for the active material. This enables both excellent transport of the electrical energy from the intercalation site to the current collector, whilst providing a large effective diffusion D_{eff} in the electrolyte. Hereby, a portion of fibers' orientation is parallel to the ion flux, thus the surface diffusion phenomenon enhances the ion flow within the electrodes. This effect significantly improves the overall performance of thick batteries, i.e. batteries with an electrode having a thickness in the range of equal to or greater than 200 μm.

Microstructural simulations show the influence of the fiber's conductivity vs the fiber density in the network on the local potential distribution through the electrode material. The effect of the high diffusivity enabling the ultrathick electrodes to function is related to the increased diffusivity of lithium ions. Simulation shows the surface diffusion effect on fiber network, with the purpose of showing the enhanced diffusion not only enabling the ultrathick electrode to function but also reducing the overpotential in electrodes.

Preferred embodiments of the present invention are the subject-matter of dependent claims and described in the following

Preferably the thickness of the network of metal fibers is in a range of greater than 500 μm, particular greater than 550 μm, more particular greater than 600 μm, even more particular of 750 μm or greater. With the network having such a thickness, it is possible to provide ultrathick electrodes. Due to the fibers being in contact, preferably sintered, to one another, there is direct electrical communication between the fibers, providing a high network conductivity in terms of electric conductivity and ion diffusion. In turn, the local potential is distributed homogenously over the volume of the electrode, reducing overpotentials, formation of hot spots and other phenomena that reduce life time of battery components, such as the electrolyte. Further, ultrathick electrodes provide a high areal capacity and reduce the fraction of inactive components, i.e. also the performance per mass unit of the battery is improved. The thickness of the network is not particularly limited. However, in view of homogenous potential distribution over the whole network, thickness is preferably 5 mm or less, even more preferably 4 mm or less, and even more preferably 3 mm or less.

It may be preferable that the metal fibers comprise a length of 1.0 mm or more and/or a width of 100 μm or less and/or a thickness of 50 μm or less. With the metal fibers having such dimensions, it is possible to produce the network with metal fibers that are fixed to one another, without needing to heat the metal fibers for a time of more than 30 minutes to temperatures close to their melting point. Conventional sintering techniques require temperatures close or even slightly above the melting temperature of the metal to be maintained for a relatively long period of time. This can result in melting or at least softening the material of the metal fibers to a certain degree, so that the metal fibers form a metal foil rather than a network, in particular when relatively high pressure is applied during sintering. Since the network of metal fibers is not a metal foil, i.e. the structure of the metal fibers used for producing the network of metal fibers can still be recognized in the network of metal fibers. Accordingly, in a cross-sectional view of network of metal fibers, there are voids which are not part of the metal fibers but are in between the metal fibers of the network fibers.

It is also preferable if the metal fibers have a width of 80 μm or less, more preferable of 70 μm or less, even more preferable of 40 μm or less and most preferably of 10 μm or less. In addition, it is preferable that the metal fibers have a thickness of 50 μm or less, more preferably of 30 μm or less, even more preferably of 10 μm or less and most preferably of 5 μm or less.

In accordance with the present invention, it is preferable that the metal fibers, before fixing them one to another, show an exothermic event when heated in a DSC measurement, wherein the exothermic event releases energy in an amount of 0.1 kJ/g or more, more preferably in an amount of 0.5 kJ/g or more, even more preferably in an amount of 1.0 kJ/g or more and most preferably in an amount of 1.5 kJ/g or more. The absolute amount depends very much on the used metal or metal alloy. The extent of the exothermic event can be determined by comparing DSC measurements of the metal fibers before and after thermal equilibration. In other words, the metal fibers showing such an exothermic event are not in their thermodynamic equilibrium at ambient temperatures. During heating in a DSC measurement, the metal fibers can transit from a metastable to a thermodynamically more stable condition, e.g. by crystallization, recrystallization or other relaxation processes reducing defects in the lattice of metal atoms. An exothermic event observed for the metal fibers when being heated, e.g. during a DSC measurement, indicates that the metal fibers are not in their thermodynamic equilibrium, e.g. the metal fibers can be in an amorphous or nanocrystalline state containing defective energy and/or crystallization energy which is released during heating of the metal fibers due to occurrence of crystallization or recrystallization. Such events can be recognized e.g. using a DSC measurement. It was found that networks of metal fibers which show such an exothermic event have an improved strength after the metal fibers are fixed to one another.

Preferably the metal fibers comprise a non-round cross section, in particular a rectangular, quadratic, partial circular, such as a crescent shaped, or an elliptical cross section with a large axis and a small axis. Such cross-sections usually lead to fibers which are not in their thermal equilibrium, i. e. in a metastable state, which, for some applications, may be beneficial.

In this connection it is noted that, obviously, the value of the small axis must be smaller than the value of the large axis. In the case in which the small axis comprises a higher value, i.e. a greater length, than the large axis, the definition of “small” and “large” must simply be interchanged.

It may be preferred that a ratio of the small axis to the large axis lies in the range of 1 to 0.05, preferably in the range of 0.7 to 0.1, in particular in the range of 0.5 to 0.1. As it is generally known, the ratio between the lengths of the small and the large axis of an ellipse is higher the more the ellipse looks like a circle, for which the ratio would be 1. The smaller the value of the ratio is, the flatter is the ellipse. Thus, the ratio of the small axis to the large axis is in particular less than 1.

Alternatively, the metal fibers may comprise a round cross-section. For such a cross-section a ratio of a “large” axis to a “small” axis would obviously be exactly 1. Round cross-sections comprise an energetically more preferred state the cross-sections comprising an aspect ratio that is smaller than 1. Hence, fibers with round cross-sections are energetically closer to their equilibrium state than fibers with cross-sections of other shapes.

According to another embodiment of the invention, the metal fibers are obtainable by subjecting a molten material of the metal fibers to a cooling rate of 10² K·min⁻¹ or higher, in particular by vertical or horizontal melt spinning. Such metal fibers produced by melt spinning can contain spatially confined domains in a high-energy state (i. e. in a metastable state), due to the fast cooling applied during the melt spinning process. Fast cooling in this regard refers to a cooling rate of 10² K·min⁻¹ or higher, preferably of 10⁴ K·min⁻¹ or higher, more preferably to a cooling rate of 10⁵ K·min⁻¹ or higher.

Also, fibers obtained by melt spinning often comprise a rectangular or semi-elliptical cross section, which are preferred for certain application fields since they are far away from their equilibrium state. Examples for melt spinners with which such fibers can be produced are for example known from the not yet published international application PCT/EP2020/063026 and from published applications WO2016/020493 A1 and WO2017/042155 A1, which are hereby incorporated by reference.

According to another example, at least some of the metal fibers are amorphous or at least some of the metal fibers are nanocrystalline. Nanocrystalline metal fibers contain crystalline domains. Upon heating to a temperature of about 20-60% of the melting temperature of the nanocrystalline metal fibers, these domains undergo recrystallization resulting in an increase of the average size of crystalline domains compared to the average size of the initial crystalline domains in the nanocrystalline metal fibers before heating. It is also possible to mix non-equilibrated (e.g. nanocrystalline or amorphous fibers) with equilibrated (e.g. annealed) fibers.

The metal fibers are in direct electrical contact with one another, since they are sintered to one another. Preferably, this is achieved by sintering the metal fibers to one another by the material of the metal fibers, i.e. the points of contact between the metal fibers which fix the metal fibers to one another consist of the same material as the metal fibers. Preferably, no binder such as a solder or organic binders is present. This allows for a high electric conductivity between the fibers and consequently for a high network conductivity. With a high network conductivity, the local potential is homogenously, i.e. the current density is locally decreased in the active material by orders of magnitude, which results in lower ohmic resistance, less electrolyte decomposition and less temperature evolution. Eventually, providing a longer lifetime for the battery utilizing the electrode according to the present invention.

Preferably, the network conductivity is equal to or greater than 1×10⁵ S/m, in particular equal to or greater than 5×10⁵ S/m, in particular equal to or greater than 1×10⁶ S/m. Such high network conductivity improves homogenous distribution of the local potential, even when the density of the three-dimensional network of metal fibers is low. Network conductivity can be measured using a four-point probe measurer.

It is preferred that a porosity of the three-dimensional network of metal fibers is in the range of 95 vol % to 99.5 vol %, in particular in the range of 96 vol % to 99.4 vol %, in particular in the range of 97 vol % to 99.0 vol %. Such high porosity allows the addition of large amounts of active electrode material, reducing the fraction of inactive components and thereby improving battery performance per mass. The porosity can be determined using a micro-computertomograph to reproduce the fiber structure and then evaluate the porosity using the bubble point method described herein.

It is possible to incorporate active materials into the open pores, such as active electrode materials or active catalyst materials. It is further preferable that in the network according to the invention at least some of the metal fibers of the plurality of metal fibers are at least partially coated. The coating can for example be an active material, such as an electrode active material which interacts with Li-ions in batteries By way of example, such active electrode materials for batteries are: for the anode: Graphite, Silicon, Silicon-Carbide (SiC) and Tin-Oxide (SnO), Tin-Dioxide (SnO2) and Lithium-Titanoxide (LTO); and for the cathode: Lithium-Nickel-Manganese-Cobalt-Oxide (NMC), Lithium-Nickel-Cobalt-Aluminium-Oxide (NCA), Lithium-Cobalt-Oxide (LiCoO2) and Lithium-Iron-Phosphate (LFP).

It is also preferable that the volume fraction of metal fibers in the three-dimensional network of metal fibers is equal to or greater than 0.075 vol %, in particular equal to or greater than 1.3 vol %, in particular 2.0 vol % or greater. Networks with lower volume fractions may have difficulties to homogenously distribute the local potential, in turn this might result in formation of hot spots and high overpotentials. Accordingly, with the volume fraction of the metal fibers in the three-dimensional network of metal fibers as specified above, battery life can be increased. The volume fraction of metal fibers in the tree-dimensional network of metal fibers can be determined using a micro-computertomograph to reproduce the fiber structure and then evaluate the fraction using the bubble point method described herein.

It is particularly preferred that the three-dimensional network has a conductivity of equal to or greater than 1×10⁵ S/m, in particular equal to or greater than 5×10⁵ S/m, in particular equal to or greater than 1×10⁶ S/m, a porosity in the range of 95 vol % to 99.5 vol %, in particular in the range of 96 vol % to 99.4 vol %, in particular in the range of 97 vol % to 99.0 vol %, and a volume fraction of metal fibers in the three-dimensional network of metal fibers of equal to or greater than 0.075 vol %, in particular equal to or greater than 1.3 vol %, in particular 2.0 vol % or greater.

Preferably the metal fibers are in direct electrical contact with one another such that the electrical conductivity can be enhanced to a maximum. In this regard it is particularly preferable that all of the metal fibers are sintered to other metal fibers, most preferable directly to other metal fibers, without the need of an additional binder, e.g. a polymeric binder or solder. It is therefore further preferred that the metal fibers are fixed to one another without a polymeric binder, since such polymeric binders often have a poor electrical conductivity and high temperature performance.

It may be preferable that the metal fibers contain at least one of copper, silver, gold, nickel, palladium, platinum, cobalt, iron, chromium, vanadium, titanium, aluminum, silicon, lithium, manganese, boron, combinations of the foregoing and alloys containing one or more of the foregoing, such as CuSn8, CuSi4, AlSi1, Ni, stainless steel, Cu, Al or vitrovac alloys. Vitrovac alloys are Fe-based and Cobased amorphous alloys. It may particularly be preferred if the metal fibers are made of copper or of aluminum or of a stainless steel alloy. Different types of metal fibers can be combined with each other, so that the filter can contain for example metal fibers made of copper, one or more stainless steel alloys and/or aluminum. Networks being made out of metal fibers, wherein the metal fibers are of copper, aluminum, cobalt, stainless steel alloys containing copper, aluminum, silicon and/or cobalt, are particularly preferred.

The fibers can be sintered to one another, as described for example in WO 2020/016240 A1

In accordance with the present invention, it is preferable that the metal fibers, before fixing them one to another, show an exothermic event when heated in a DSC measurement, wherein the exothermic event releases energy in an amount of 0.1 kJ/g or more, more preferably in an amount of 0.5 kJ/g or more, even more preferably in an amount of 1.0 kJ/g or more and most preferably in an amount of 1.5 kJ/g or more. The absolute amounts depend very much on the used metal or metal alloy. The extent of the exothermic event can be determined by comparing DSC measurements of the metal fibers before and after thermal equilibration. In other words, the metal fibers showing such an exothermic event are not in their thermodynamic equilibrium at ambient temperatures. During heating in a DSC measurement, the metal fibers can transit from a metastable to a thermodynamically more stable condition, e.g. by crystallization, recrystallization or other relaxation processes reducing defects in the lattice of metal atoms. An exothermic event observed for the metal fibers when being heated, e.g. during a DSC measurement, indicates that the metal fibers are not in their thermodynamic equilibrium, e.g. the metal fibers can be in an amorphous or nanocrystalline state containing defective energy and/or crystallization energy which is released during heating of the metal fibers due to occurrence of crystallization or recrystallization. Such events can be recognized e.g. using a DSC measurement. It was found that networks of metal fibers which show such an exothermic event have an improved strength after the metal fibers are fixed to one another.

Preferably the metal fibers comprise a non-round cross section, in particular a rectangular, quadratic, partial circular or an elliptical cross section with a large axis and a small axis. Such cross-sections usually lead to fibers which are not in their thermal equilibrium, i. e. in a metastable state, which, for some applications, may be beneficial.

In this connection it is noted that, obviously, the value of the small axis must be smaller than the value of the large axis. In the case in which the small axis comprises a higher value, i.e. a greater length, than the large axis, the definition of “small” and “large” must simply be interchanged.

It may be preferred that a ratio of the small axis to the large axis lies in the range of 1 to 0.05, preferably in the range of 0.7 to 0.1, in particular in the range of 0.5 to 0.1. As it is generally known, the ratio between the lengths of the small and the large axis of an ellipse is higher the more the ellipse looks like a circle, for which the ratio would be 1. The smaller the value of the ratio is, the flatter is the ellipse. Thus, the ratio of the small axis to the large axis is in particular less than 1.

Alternatively, the metal fibers may comprise a round cross-section. For such a cross-section a ratio of a “large” axis to a “small” axis would obviously be exactly 1. Round cross-sections comprise an energetically more preferred state the cross-sections comprising an aspect ratio that is smaller than 1. Hence, fibers with round cross-sections are energetically closer to their equilibrium state than fibers with cross-sections of other shapes.

Preferably, the metal fibers used in the electrode of the present invention are obtainable by subjecting a molten material of the metal fibers to a cooling rate of 10² K min⁻¹ or higher, in particular by vertical or horizontal melt spinning. Such metal fibers produced by melt spinning can contain spatially confined domains in a high-energy state (i. e. in a metastable state), due to the fast cooling applied during the melt spinning process. Fast cooling in this regard refers to a cooling rate of 10² K·min⁻¹ or higher, preferably of 10⁴ K·min⁻¹ or higher, more preferably to a cooling rate of 10⁵ K·min⁻¹ or higher.

Also, fibers obtained by melt spinning often comprise a rectangular or semi-elliptical cross section, which are preferred for certain application fields since they are far away from their equilibrium state. Examples for melt spinners with which such fibers can be produced are for example known from the not yet published international application PCT/EP2020/063026 and from published applications WO2016/020493 A1 and WO2017/042155 A1, which are hereby incorporated by reference.

According to another example, at least some of the metal fibers of the plurality of metal fibers are amorphous or at least some of the metal fibers of the plurality of metal fibers are nanocrystalline. Nanocrystalline metal fibers contain crystalline domains. Upon heating to a temperature of about 20-60% of the melting temperature of the nanocrystalline metal fibers, these domains undergo recrystallization resulting in an increase of the average size of crystalline domains compared to the average size of the initial crystalline domains in the nanocrystalline metal fibers before heating. It is also possible to mix non-equilibrated (e.g. nanocrystalline or amorphous fibers) with equilibrated (e.g. annealed) fibers.

The network may comprise an average mean pore size selected in the range of 0.1 to 1000 μm, preferably in the range of 0.5 to 500 μm, in particular in the range of 1 to 100 μm. The mean pore size can be determined using a micro-computertomograph to reproduce the fiber structure and then evaluate the mean pore diameter using the bubble point method. The bubble point method determines the largest ball diameter, which might fit between two fibers, which is considered the pore size. More in detail, a point is placed at the center between two fibers and the radius of the bubble, with the point as a center is increased, until contact to the surface of both fibers is made. The diameter of the bubble corresponds to the pore size. If at any given parameter the bubble diameter only contacts one fiber, the center point is displaced into the direction of the fiber that the bubble did not contact.

It is particularly preferable if the three-dimensional network of metal fibers comprised in the electrode according to the invention are fixed, in particular directly fixed, to one another at points of contact which are preferably randomly distributed throughout the network of metal fibers. According to another inventive aspect, it is preferred that the points of contact are not randomly distributed but are provided e.g. in a peripheral region of the network of metal fibers or that the metal fibers are ordered so that also the point of contacts are ordered.

It is further preferred that the points of contact at which the metal fibers are fixed to one another are localized in specific areas and not provided evenly over the complete network of metal fibers. With the points of contact at which the metal fibers are fixed to one another being present only in separated areas, it is possible that the fibers in-between these areas have a high flexibility while at the same time the mechanical stability and good electrical conductivity is ensured.

Preferably the spatial orientation of the metal fibers is unordered. With an unordered network, always some portions of the metal fibers are oriented in the direction of the ion flux. Thereby ion diffusivity is increased on the surface of the metal fibers, allowing to obtain the effects of the present invention.

Preferably, the spatial orientation of the metal fibers is at least partially ordered. Accordingly, there is a predominant spatial direction of the metal fibers in one direction. Thereby, the portion of metal fibers being oriented in the direction of the ion flux can be increased, yielding even higher ion diffusivity. Orientation of metal fibers may be achieved, e.g. by carding of the metal fibers, before sintering them to the tree-dimensional network of metal fibers.

Preferably, the density of the points of contact is in a range of 1 mm⁻³ to 5000 mm⁻³. More preferably, the density of the points of contact is in a range of 3 mm⁻³ to 2000 mm⁻³, even more preferably in a range of 5 mm⁻³ to 500 mm⁻³. The density of points of contacts can also be regarded as a crosslinking density between the fibers, since at the points of contact the metal fibers are directly fixed to one another and are in electric contact with one another. With a fiber density of 1 mm⁻³ or higher, in particular 5 mm⁻³ or higher, homogenous distribution of the potential is realized, avoiding detrimental effects, such as high overpotential or creation of local hot areas due to a high resistance. In turn, density of points of contacts of 5000 mm⁻³ or lower, in particular of 2000 mm⁻³ or lower, more particular of 500 mm⁻³ or lower is useful for providing flexibility to the three-dimensional network of metal fibers, so that even rather thick three-dimensional networks, i.e. with a thickness of 200 μm or greater, of 500 μm or greater, or of 550 μm or greater, or of 600 μm or greater or of 750 μm or greater, can be deformed, e.g. rolled, without causing the network to break.

Further, the present invention concerns a battery, comprising an electrode according to any one of the previous claims.

Preferably, the battery is a lithium ion battery, a sodium ion battery, a calcium ion battery, potassium ion battery, an aluminum ion battery, a zinc ion battery, a dual ion battery. A dual ion battery is based on simultaneous intercalation of a positive ion and its corresponding negative ion or ion complex, e.g. PF₆⁻, ClO₄⁻. Most preferably it is a lithium ion battery.

Preferably, the battery comprises one electrode according to the present invention, wherein the metal fibers consist of copper or a copper alloy.

Preferably, the battery comprises one electrode according the present invention, wherein the metal fibers consist of aluminum or an aluminum alloy.

Further, the present invention concerns an electric machine comprising a battery according to the present invention. In particular, the battery in accordance with the present invention provides power to a circuit of the electric machine. Further, it is preferable that the circuit of the electric machine provides power to a motor for propelling the electric machine, in particular an electric vehicle.

The invention will now be described in further detail and by way of example only with reference to the accompanying drawings and figures as well as by various examples of the network and method of the invention. In the drawings there are shown:

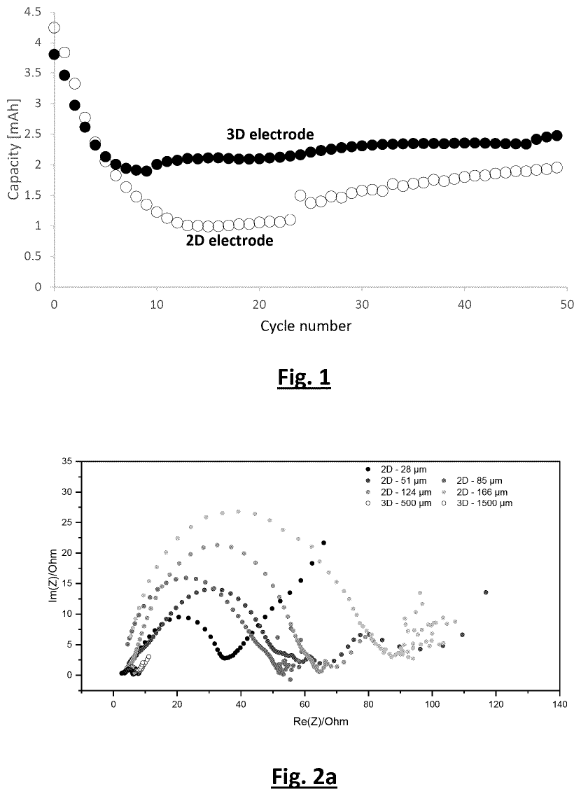

FIG. 1 comparison of a 2D and 3D graphite-based electrode with similar areal capacities. The cycling was done at a C-Rate of 0.5C.

FIG. 2a Nyquist plot for 2D and 3D electrodes of different thicknesses.

FIG. 2b illustration of equivalent circuit

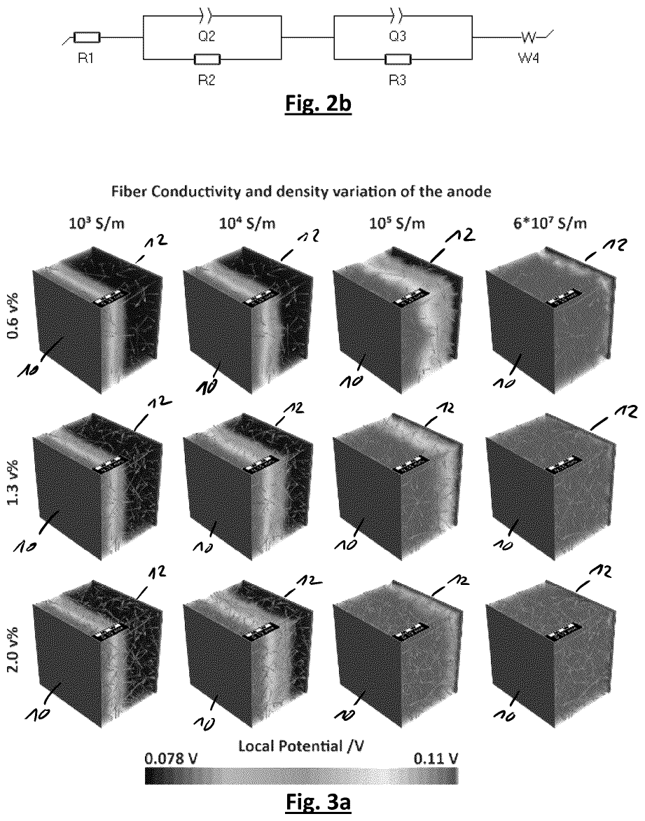

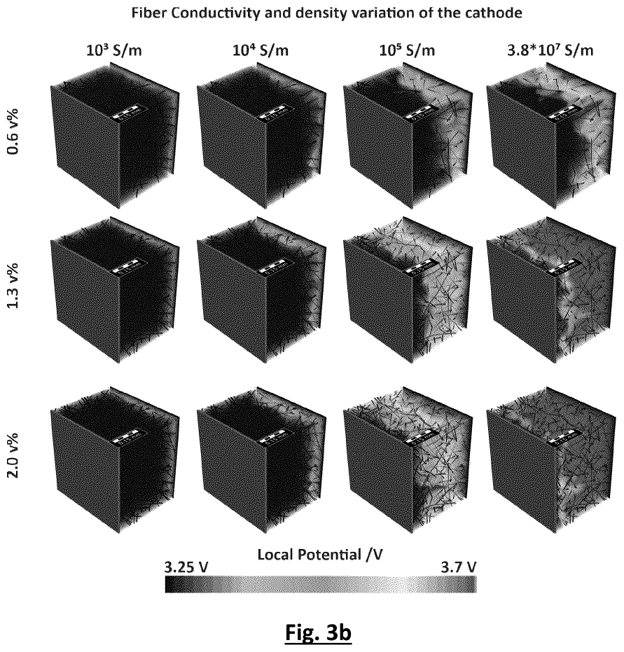

FIG. 3a potential distribution of the anode of a graphite-based 3D metal fiber network electrode with a thickness of 400 μm for different fiber volume fractions and different fiber conductivities.

FIG. 3b potential distribution of the cathode of a graphite-based 3D metal fiber network electrode with a thickness of 400 μm for different fiber volume fractions and different fiber conductivities.

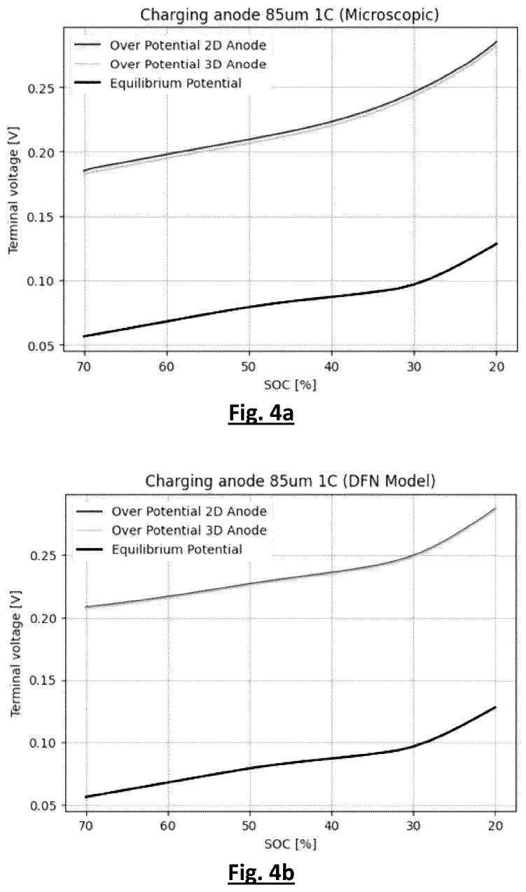

FIG. 4a simulated potentials of 2D and 3D electrodes at charging rates of 1C with electrode thicknesses of 85 μm using microscopic model.

FIG. 4b simulated potentials of 2D and 3D electrodes at charging rates of 1C with electrode thicknesses of 85 μm using DFN model.

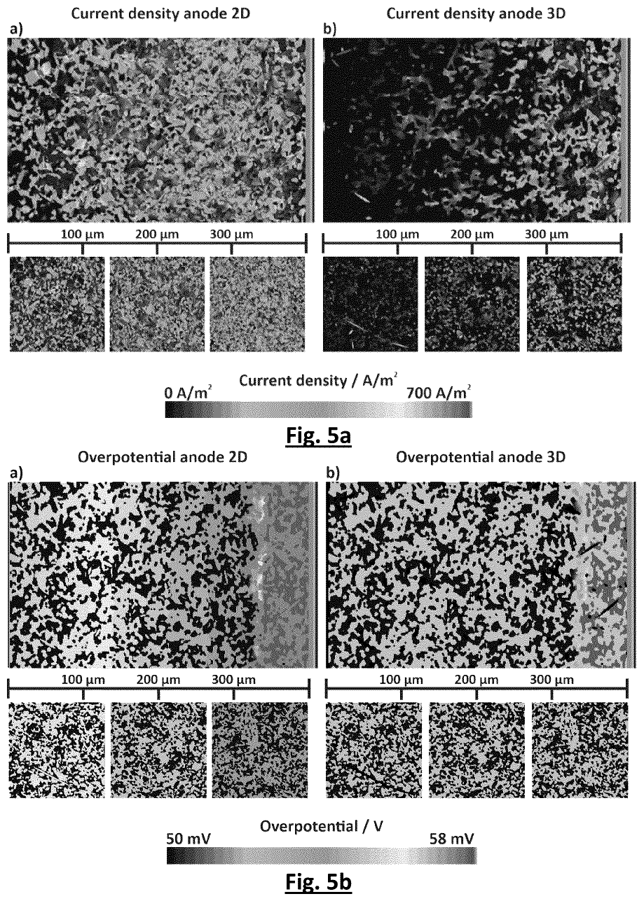

FIG. 5a simulated current densities along the thickness of a 2D anode electrode (a) and a 3D metal fiber based anode electrode (b).

FIG. 5b simulated current densities along the thickness of a 2D cathode electrode (a) and a 3D metal fiber based cathode electrode (b).

FIG. 5c DFN-model based macroscopic simulations of discharge curves for 3d electrodes of different thicknesses.

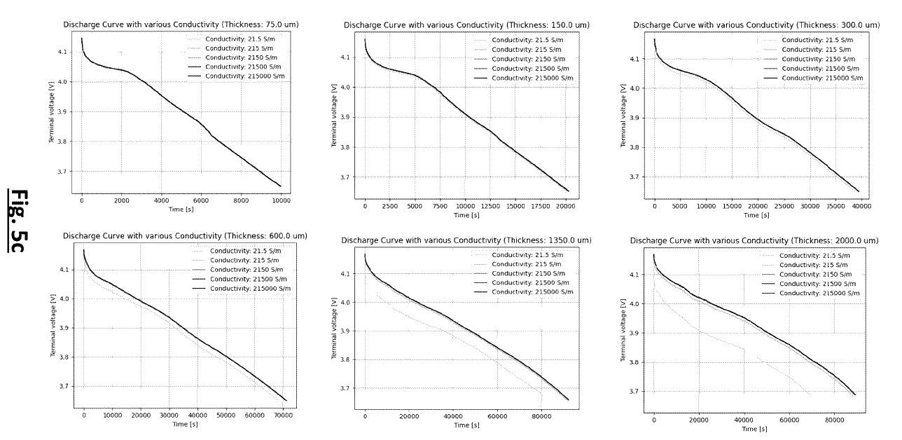

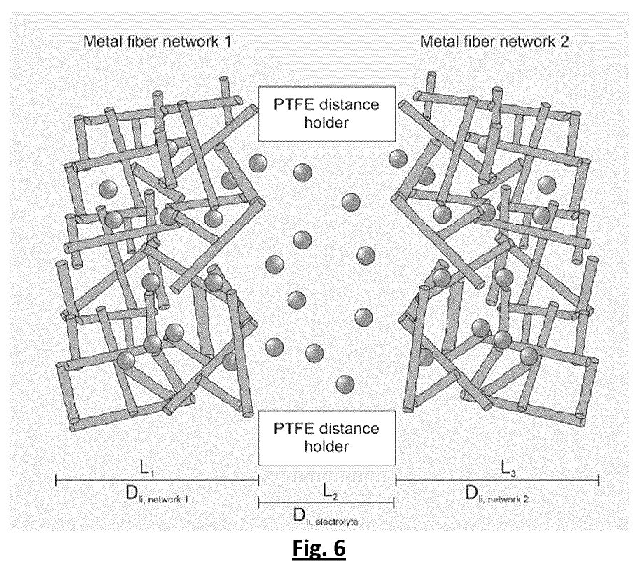

FIG. 6 schematic structure of a symmetric cell in accordance with the invention.

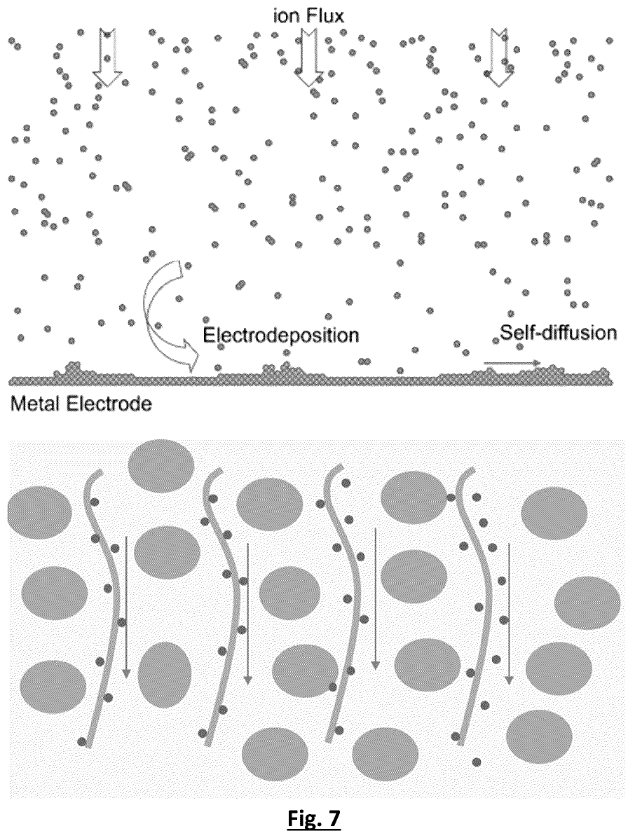

FIG. 7 schematic illustration of ion adsorption on metal fiber surface.

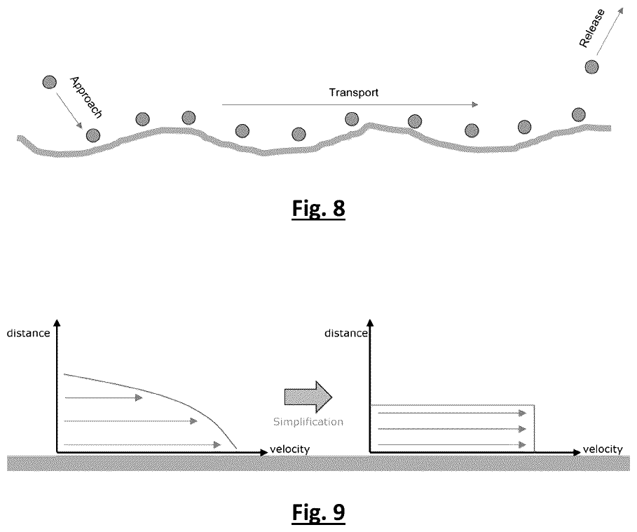

FIG. 8 schematic illustration of the mechanism of an ion transport along the fibers' surface.

FIG. 9 schematic illustration of laminar flow and its corresponding simplified counterpart in order to simulate the diffusion along a surface.

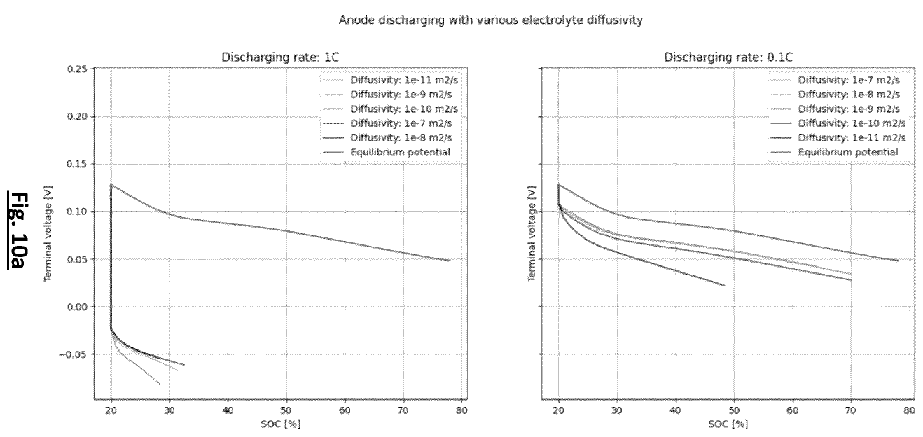

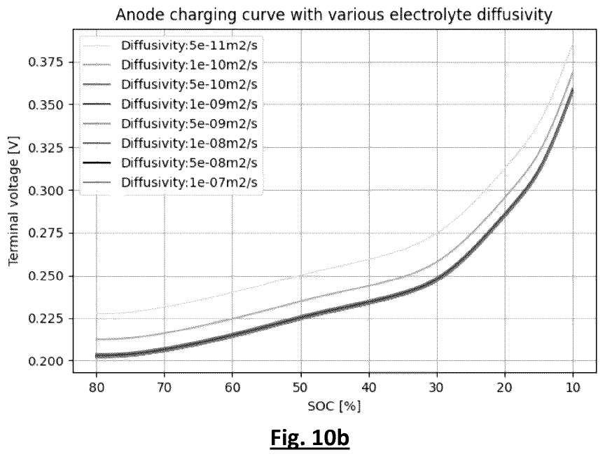

FIG. 10a simulated potentials of 3D electrodes at anode discharging rates of 1C and 0.1C, respectively for different electrolyte diffusivities, electrode thickness 85 μm.

FIG. 10b simulated potentials of 3D electrodes at anode charging for different electrolyte diffusivities, electrode thickness 85 μm.

FIG. 11 simulated potentials of 3D electrodes at anode charging for different electrolyte diffusivities, electrode thickness 400 μm.

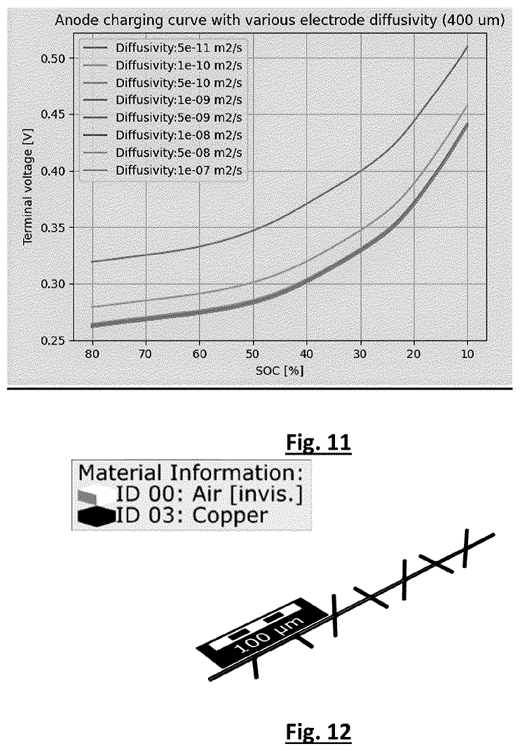

FIG. 12 Model of electrode used for simulating microscopic model.

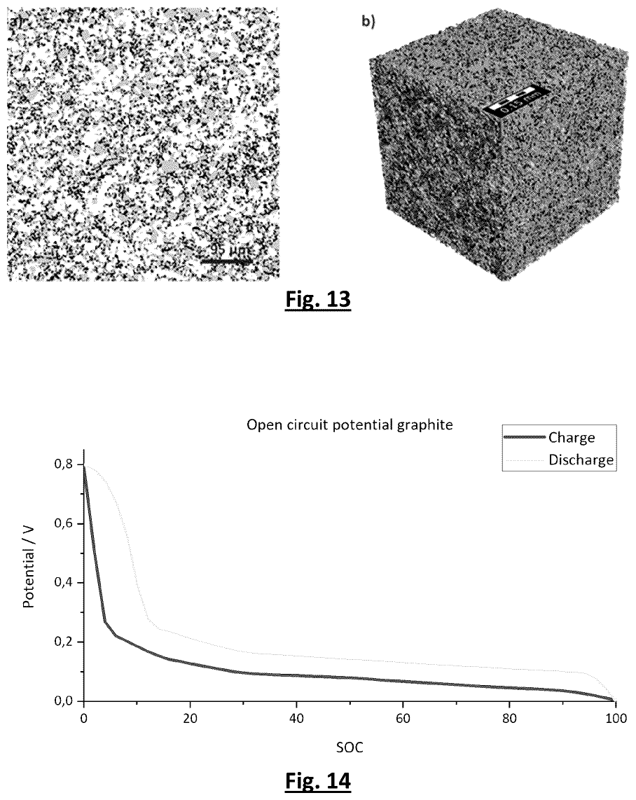

FIG. 13 Cross-section (a) and 3D view of the electrodes active material (Red) and binder (green).

FIG. 14 The charge-discharge equilibrium profile of graphite.

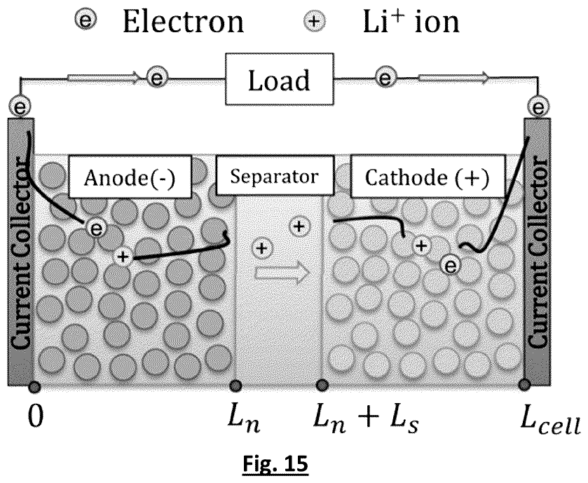

FIG. 15 Schematic description of Doyle-Fuller-Newman (DFN) model.

### 2D VS 3D BATTERIES IN EXPERIMENTAL OBSERVATIONS

In order to investigate the performance of an ultrathick electrode with a 3D current collector backbone (Henceforth called 3D electrode) in comparison with a 2D metal foil-based electrode (Henceforth called 2D electrode), both electrodes were fabricated with a similar areal capacity. As shown in FIG. 1, a 25% increase in accessible capacity in case of the 3D electrode was observed. The higher capacity, which is observed for the 3D electrode can be explained by an enhanced ion transport capability as well as the increase in electrical conductivity, according to Gao et al. [12] Thus, more active material is utilized during the charging/discharging process, which results in a higher capacity of the 3D electrode.

In order to separate the effect of the enhanced (electronic) conductivity from the increased ion transport capabilities of the 3D electrode, we have first compared the charge-transfer resistance and internal resistivity of 2D electrode with different active material loadings (i.e. active material layer thickness) with the charge transfer resistance of ultrathick 3D electrodes, see FIG. 2.

### 3D Vs 2D Electrical Conductivity Experimental Observations

On the basis of the EIS measurements on half-cells, a clear difference of the electrical conductivity between 2D and 3D electrode can be observed. Hereby, different 2D electrodes with active material layer thicknesses of 28 μm, 51 μm, 85 μm, 124 μm and 166 μm, respectively, were investigated using EIS and compared to 3D electrodes with a thickness of 500 μm and 1500 μm, respectively. The resulting Nyquist plots as shown in FIG. 2a were fitted using the fitting software Z-Sim from EC-Lab and the equivalent circuit was designed according to FIG. 2b. Since EIS measurements on half-cells are prone to side reactions, when not in equilibrium, which distort the half-cycle shape and onset, all measurements were conducted at 0.143 V.

As can be visually observed in FIG. 2a, a similar internal resistance for all electrodes is obtained (corresponding to the onset of the Nyquist-Plot at Im(Z)=0). The values range hereby between 0.3 Ohm up to 1.9 Ohm, and can be ascribed to the contact resistance between the respective electrode and the steel housing. However, large differences are observed for the charge-transfer resistance (diameter of the semi-circle). The charge-transfer (lithium ion transfer) resistance varies with the number of the accessible lithium intercalation sites, thus the amount of available active material.[18] This effect is clearly visible for the active material layers with different thicknesses in case of the 2D electrode. Hereby, the larger number of available lithium intercalation sites for larger areal loadings and the large contact resistance between the single particles correlates well with the increase in charge-transfer resistance.[19]

However, in case of the 3D network, a significant decrease in charge-transfer resistance has been observed. This effect became even more pronounced for a network of 1.5 mm thickness. Hereby, the active material nevertheless has a large number of intercalation sites, since they relate to the active material loading (capacity per area). The active material loadings of the 3D electrode (500 μm) and of the largest 2D electrode (2D—166 μm) are comparable to one another since areal capacity is in both cases around 4 mAh cm². However, in case of the electrode of the present invention, the active material of the 3D electrode is connected well with the metallic fiber backbone and due to the high conductivity of the metal fibers, the ohmic drop over the electrodes thickness is significantly reduced.

An additional effect observed during charging/discharging of the electrode, the ageing of the electrode due to the high current density, can be overcome, since the long-range electron transfer is taking place in the metal fiber network. Summarizing, in the electrode of the present invention utilizing the metal fiber network results in a significant decrease in charge-transfer resistance. This experimentally observed effect is still not able to provide a sufficient explanation for the observed improved performance of the 3D electrode. According to Vlad et al.[20] ultra-thick batteries suffer from
(i) high polarization due to the high ohmic resistance,
(ii) less efficient current collection and
(iii) lower ionic conduction through the electrode

By application of a 3D current collector, as in the electrode of the present invention, and the measurements conducted up to now, we were able to overcome effect (i) and (ii) with a metallic 3D current collector. While for conventional 2D electrodes a dense active material layer is required to decrease the contact resistance between the active material particles, the thickness of such a layer is also limited, as shown by the Nyquist plots of FIG. 2a. In order to supply sufficient ions, e.g. Li ions, to the intercalation sites, a short ion diffusion path is required to utilize the active material to its fullest, especially when higher currents are applied (i.e. fast charging).

In order to visualize these findings locally, a multiscale simulation based on a finite volume model (FVM) was conducted.

### 3D Simulations of the Conductivity (DFN and Microscopic)

Simulation results are illustrated in FIGS. 3a and 3b. FIGS. 3a and 3b show the potential distribution of a graphite-based 3D metal fiber network electrode with a thickness of 400 μm. For simulation of FIG. 3a, a potential of 0.11 V is set as initial value on the current collector plane 10 of all electrodes, whereas the counterelectrodes' 12 potential is set to 0 V. For simulation of FIG. 3b, a potential of 3.7 V is set as initial value on the current collector plane of all electrodes, whereas the counterelectrodes' potential is set to 0 V. The potential was selected corresponding to the peak intercalation potential (upper limit in color coding) obtained from CV measurements on graphite, whereas the lower limit is its full width—half maximum (FWHM). Simulations were made for networks having fiber densities of 0.6 vol. % (first row in FIGS. 3a and 3b), 1.3 vol. % (second row in FIGS. 3a and 3b) and 2.0 vol. % (third row in FIGS. 3a and 3b). In FIGS. 3a and 3b the first column represents a fiber conductivity of 103 S/m, second column of 10⁴ S/m, third column of 10⁵ S/m and fourth column of FIG. 3a of 6×10⁷ S/m and of FIG. 3b of 3.8×10⁷ S/m. As can be readily recognized for a high conductivity of 6×10⁷ S/m or 10⁵ S/m the local potential is homogeneous distribute, irrespective of the fiber density.

As shown in FIG. 3a, a conductivity of 10⁵-10⁶ S m⁻¹ (corresponding to the axial conductivity of a single carbon nanotube (CNT))[21] is sufficient for a homogeneous potential distribution through the electrode and the minimization of the ohmic resistance at all given fiber densities. However, measurements of CNT yarns[22] show, that only a conductivity of 1-4*10⁴ S m⁻¹ is obtained, since CNT's do not form a connected network, but instead have large contact resistances at the contact points of single fibers. As the simulation reveals, for ultra-thick electrodes the conductivity of a CNT network (10⁴ S m⁻¹) is not sufficient to obtain a homogeneous potential distribution. In case of a cathode simulation this effect becomes much more pronounced, since the inherent conductivity of the cathodes active material is much lower, as displayed in FIG. 3b.

In order to compare the influence of the 3D electrode with a conventional 2D electrode on the battery performance, a half-cell battery simulation was carried out. Hereby, the overpotentials of the charging and discharging processes are used to simulate the battery performance. However, the change in overpotential is neither significant based on microscopic simulation (FIG. 4a) nor in macroscopic simulation using the DFN model (FIG. 4b).

With an increasing thickness of the electrode, the overpotential difference between 2D and 3D electrode becomes more distinct but is still negligible, as shown in FIGS. 4a and 4b.

Along this line, we had a closer look at the current density distribution in both electrodes i.e. 2D and 3D electrodes, since electrolyte decomposition is mainly influence by either additional SEI formation and decomposition at high current densities.[2,23] As shown in FIG. 5a the current density through the active material is lowered significantly for the 3D electrode utilizing the three-dimensional network of metal fibers. Due to the high metallic conductivity present in the metal fiber network, the electric current in the electrode accumulates in the fibers. The presence of the metal fiber network not only lowers, but also homogenizes the current density throughout the active material, especially in high thickness electrodes, as visually shown in FIG. 5a.

Furthermore, since the ohmic resistance is the main factor for the temperature increase at large C-Rates (large current densities) and as such the aging associated with the temperature, longer electrode life-times are expected.[2] Hereby, the ohmic heat is reduced due to generally lower current densities present in the active material. Thus, the thermal stress within the electrode as well as degradation within the active material during long-term cycling are significantly reduced for the electrode according to the present invention. Additionally, the high thermal conductivity of the metal fibers enables also the efficient heat conduction and distribution, further impeding the development of large local heat sources.

With the DFN-model based macroscopic simulations (FIG. 5c), we were able to simulate not only half cells, as simulated in FIG. 3 and FIG. 4, but full cells with electrodes of a thickness of up to 2 mm, however only a minor difference in the overpotential between the 3D and 2D electrode was observed. FIG. 5c shows a battery performance versus the active material thickness. Simulation was carried out with macroscopic DFN (Doyle-Fuller-Newman) model. The discharging current is 0.1C, with different conductivity of active material. From FIG. 5c it can be observed that conductivity increase of the active material almost does not contribute in thin layer electrode, from 300 μm to 2000 μm, we could see a difference in overpotential due to the electrode's conductivity, however the influence is still minimal. Consequently, the simulation demonstrates, that the overpotential of a 3D electrode compared to its 2D counterpart is not decreased as significantly as the experimental investigations show. Furthermore, the simulations of the different electrode thicknesses also show that for ultrathick electrodes, at a certain depth the lithium ion concentration in the electrolyte drops to zero. This indicates that beyond this depth, the intercalation process is stopped and the active material will not participate in the reaction, thus is under-utilized. This is in good accordance with our findings for ultra large 2D electrodes, but consequently cannot explain the significantly better performance of the 3D electrode.

Thus, these findings indicate that for ultrathick electrodes, the ion transport ability is the primary limitation of the battery performance. Hence, without being bound to a theory, it is assumed that a 3D metal fiber network is able to enhance the ion diffusion within the porous electrode. In order to quantify this effect, the experimental electrodes are investigated quantitatively using electrical impedance spectroscopy (EIS) technique.

### 3D Measurements on the Diffusivity

Several studies on the diffusivity of lithium in the electrolyte have been conducted, using techniques like pulsed gradient spin echo nuclear magnetic resonance PGSE-NMR[24], electrical impedance spectroscopy (EIS)[12] or galvanostatic intermittent titration technique (GITT).[12] The determination of the diffusivity in an electrolyte could easily be done by PGSE-NMR, which would, out of the 3 technique also be the most accurate. However, due to the large alternating magnetic fields, which are applied during the measurements, currents are induced into metallic conductors (i.e. the fibers in the electrode), rendering the measurement impossible. In order to overcome this hurdle, we have investigated the diffusivity of the electrolyte using EIS on symmetric cells and directly comparing copper foil current collectors (prepared according to Comparative Example 1) to CuSi4 metal fiber current collectors (prepared according to Example 1), according to the schematic illustration of FIG. 6 at a voltage of 0 V. From these measurements we have fitted the Warburg resistance and determined the specific Warburg coefficient σ. The advantage of the symmetric cell is, that no further side reaction of the active material, electrolyte decomposition, SEI formation or similar effects occur and the sole influence of the current collector and its structure on the diffusivity of the electrolyte is measured.

Hereby, the thickness of both 3D current collectors is 500 μm, kept apart by a distance holder with a thickness of 1 mm. These measurements were compared with the same assembly, using copper foils instead of a metal fiber network. Using the Software Z-Fit, the values for the Warburg coefficient were obtained by fitting the measurements with a Warburg element as displayed in Table 1. The Warburg coefficient σ fit was performed with:

$${Z}_{w} = \frac{\sqrt{2} σ}{\sqrt{i 2 π f}} \qquad [ 1 ]$$

TABLE 1
Determination of the Warburg coefficient, depending
on the current collectors architecture

| | 2D (Foil) | 3D (Metal fiber network) |
|---|---|---|
| Thickness [μm] | 20 | 500 |
| Sigma | 26543 | 7396 |

We were able to measure a significantly smaller Warburg coefficient for the 3D current collectors, under the exclusion of any side effects from the active material (e.g. increased tortuosity). According to Equation 2, the Warburg coefficient σ is proportional to D_{eff}², thus the smaller the Warburg coefficient is, the larger the effective diffusivity is. To our best knowledge, this large increase in diffusivity in the presence of metallic fibers has not yet been considered in literature. We hypothesize without being bound to a theory, in case of the metallic fibers, a portion of the fibers is oriented perpendicular to the ion flux, thus diffusion along the fibers is contributing to the effective diffusivity.

$$σ = \frac{RT}{{An}^{2} {F}^{2} \sqrt{2}} ( \frac{1}{{D}_{O}^{\frac{1}{2}} {C}_{O}^{b}} + \frac{1}{{D}_{R}^{\frac{1}{2}} {C}_{R}^{b}} ) \qquad [ 2 ]$$

In order to evaluate this increase on the diffusivity in detail, we have conducted the analysis of Warburg element in the half-cell assembly. Hereby, the diffusivity in the half-cells for 2D and 3D electrodes was compared using the EIS measurements on 0.143 V.

TABLE 2
Determination of the Warburg coefficient
of half cells with 2D and 3D electrodes

| | 3D | 3D | 2D | 2D | 2D | 2D | 2D |
|---|---|---|---|---|---|---|---|
| Electrode | 500 | 1500 | 166 | 124 | 84 | 51 | 28 |
| Thickness [μm] | | | | | | | |
| Sigma | 0.8 | 0.54 | 2.46 | 2.71 | 1.01 | 8.38 | 7.07 |

According to the values shown in Table 2, a significant difference of the Warburg coefficient σ between the 2D and the 3D electrodes is observed. Hereby it becomes apparent, that the difference between the respective Warburg coefficient obtained for the 3D electrode according to the present invention (Example 1) and their 2D (metal foil) counterparts (Comparative Example 1) is a factor of 3.6 smaller in case of the empty symmetric cells. This effect is also observed in case of the half-cell configuration and its respective measurements.

Hereby, the difference in absolute values between empty symmetric cell configuration and half-cell configuration is caused by the difference in diffusion length, counter electrodes chemical nature (metallic Li), the active material present in the electrode and the measured base voltage. It becomes apparent, that the effect becomes much more pronounces in case of the half-cell configuration, since the active material hinders the free Li Ion movement. In order to correlate this effect with the battery performance, we used the increased diffusivity as input parameter in a microscopic and macroscopic simulation.

### 3D Simulation on the Diffusivity (Microscopic and DFN)

In order to simulate the influence of the increase in diffusivity on the battery performance, microscopic half-cell and macroscopic full-cell simulation are conducted. First of all, it is hypothesized that terrace and interlayer surface diffusion have a significant influence on the ion diffusion flux. Due to the potential difference between electrolyte and fiber network, more lithium ions concentrate near the fibers, and then lithium ion diffusion occurs at the surface of the fibers and therefore the net ion diffusion is enhanced. Bairav et al.[25] depicted the similar combined phenomenon as lithium ions are deposited on the copper plates and a diffusion along the plate is observed (see also FIG. 7 upper part).

However, in case of the anode (carbon-based 3D electrode in accordance with the present invention), the lithium ions are intercalated, due to the presence of carbon. Therefore, a deposition of a large amount of lithium will not occur, but polarization ensues. Subsequently, the polarization induces the adsorption (approach & attachment) of lithium ions on the fibers surface. Consequently, these ions then diffuse along the fibers, as schematically depicted in FIG. 8.

However, due to the complex structure of the three-dimensional network of metal fibers, simulation of this physical phenomenon on a microscopic scale requires enormous computing power. Moreover, a different simulation technique would be required to simulate the movement of different ions (Monte-Carlo, molecular dynamics). In order to simplify the simulation, we employed a laminar flow mechanism to demonstrate surface diffusion. In detail, we assume in our model system, that the ion diffusion along the fibers follows the laminar flow equation, as shown in FIG. 9, left part, in which the velocity of the ion flux is decreased as a function of the distance to the fibers' surface. In order to simplify the microscopic simulations further, the laminar flow is transformed into a constant rate flow with a characteristic distance (to the fiber surface) d. Based on Hagen—Poiseuille's Law of laminar flow (Equation 3) and Fick's First law of diffusion (Equation 4), an effective diffusivity near fiber surface and the characteristic distance d can be derived. With these input parameters, a diffusivity simulation on a microscopic scale can be carried out.

$$F = η \frac{vA}{L} \qquad [ 3 ]$$

$$J = - D \frac{d φ}{dx} \qquad [ 4 ]$$

However, this increase in effective diffusivity can also be described as an increased net diffusion flux D_{eff}*∇cₑ, according to Equation 5. In order to simulate this effective diffusivity, only the increase in effective diffusivity is required.

$${D}_{eff} * ∇ c = {D}_{electrolyte} * ∇ {c}_{e} + {D}_{surface} * ∇ {c}_{s} \qquad [ 5 ]$$

The simulation was conducted on basis of a microstructural and the DFN model. Hereby, a large performance increase for an electrode with a thickness of 400 μm was observed. The effective diffusivity of the lithium ions in the electrolyte is depending on the porosity and tortuosity in the range between 1*10⁻¹⁰ and 1*10⁻¹¹ m²s. Using this value as base, a difference in diffusivity was simulated up to a diffusivity of 1*10⁻⁷ m² s. At an increasing diffusivity a decrease of the overpotential is observed. Since the intercalation rate of the active material (in this simulation graphite) is, given a sufficiently large Li Ion flow, the bottleneck, no further performance increase was observed for values lower than 1*10⁻⁹ m²s.

Comparison of two different charging rates revealed that the intercalation rate into the active material is indeed the limiting factor, since at higher charging rates, the difference in performance becomes negligible.

On the basis of a macroscopic model, as displayed in FIG. 10b, this effect is also observed. Moreover, the DFN simulation were also able to show, that beyond a certain value, no further improvement is observed.

FIG. 10b shows the battery simulation result of the overpotential (electrode thickness: 85 um), considering the surface diffusion effect of the fiber network. The overpotential on the anode side is significantly decreased when the net diffusion is increased. Worthwhile mentioning that it could be observed that once the effective ion diffusivity is larger than 5e-10 m²/s, the influence of the diffusivity on the overpotential becomes trivial, which means that battery performance jumped out of the bottle neck of the diffusivity limitation. As for an ultrathick electrode (400 um), a more distinct electrolyte's influence on the battery performance can be observed (see FIG. 11).

In the following further description of the simulation methods is provided:

### Simulation (Microscopic Model):

In order to simulate the structure of the electrodes and demonstrate the effect of the increased diffusivity, the microstructure of an electrode as modelled and simulated on basis of an increased diffusivity. The model of the electrode comprised a single metal fiber in the center of the electrode. In each 50 μm section, a vertical fiber was placed into the electrode, which is alternatingly placed 0 or 90° to the initial fiber, as displayed in FIG. 12. The simulated volume is 400×50×50 voxels with a periodic boundary condition.

The fiber network was subsequently overlapped with the active material (AM). Their particle shape and particle size distribution is based on statistical data extracted from a FIB-SEM scan provided by Math2Market.

| | | | Volume | Volume | | | Binder |
|---|---|---|---|---|---|---|---|
| | | | fraction | Fraction | | Simulated | contact |
| Shape | Overlap | distribution | AM | Binder | resolution | volume | Angle |
| polyhedral | remove | isotropic | 42.5 v % | 10 v % | 1 μm | 500 × 500 × | 10 degree |
| | | | | | | 500 voxel | |

The obtained electrode structure is shown in FIG. 13. In FIG. 3, the active material is grey and the binder is black.

In order to obtain the fibrous electrode, both structures were overlapped, cut and the overlap between both structures assigned as fiber material. A half-cell was assembled in GeoDict with a separator thickness of 6 μm and an infinite lithium reservoir as counter electrode.

The Material parameters of the respective components are specified in the following table and the respective equilibrium intercalation potential in FIG. 14.

| | | | Current | |
|---|---|---|---|---|
| | Graphite | Electrolyte | Collector | Binder |
| Density [g cm⁻¹] | 2 | 1.3 | 8.96 | Ca. 1.5 |
| Conductivity [S m⁻¹] | 100, | 1.1 | 60359400 | 10 |
| | isotropic | | | |
| Ionic diffusion | 2e⁻¹³ m²/s | 10⁻⁷-10⁻¹¹ | 0 | 0 |
| constant [m2 s⁻¹] | | | | |
| max Li | 26390 | 1200 | 0 | 0 |
| Concentration | | | | |
| [mol m⁻³ | | | | |
| Butler Volmer rate | 8.5e⁻⁷ | | 0 | 0 |
| [Am^{2.5} mol^{-1.5}] | | | | |
| Lithium transfer | | 0.399 | 0 | 0 |
| number | | | | |

### Simulation (Macroscopic Model):

In order to understand how the net diffusivity of the electrolyte influences the battery performance during charging and discharging, a macroscopic model for battery simulations is constructed. With the purpose of a parametric study, a pseudo multiscale Doyle-Fuller-Newman (DFN) model is adopted to test for instance the electrode's conductivity, diffusivity, active material particle size and charge transfer rate's impact on battery's performance.

In the DFN model, active material is regarded as well-arranged spherical particles (see FIG. 15), surrounded by electrolyte phase. Inside the particle, lithium solid-state diffusion occurs along the particles' radial direction (towards or away from the center), described by Equation [1-1].

In the liquid phase, lithium ion diffusion is defined by an ions flux between both current collectors and governed by Nernst Plank equation (Equation [1-2]); at the solid-liquid interfaces, the Butler Volmer Equation describes the dynamic property of the charge transfer rate (Equation [1-3]); Furthermore, Ohms law governs the electrons' transfer in the active material (Equation [1-4]). However, due to the nature of the DFN model, the microscopic features are neglected and microscopic-feature-related physical parameters like tortuosity and diffusivity are included using effective values.

$$\text{?} \qquad [ 1 - 1 ]$$

$$\text{?} \qquad [ 1 - 2 ]$$

$$j ( x , t ) = \frac{{i}_{θ} ( x , t )}{ℱ} [ exp ( \text{?} ) - exp ( \text{?} η ( x , t ) ) ] \qquad [ 1 - 3 ]$$

$$\text{?} = - \text{?} \qquad [ 1 - 4 ]$$

$$\text{?} \text{indicates text missing or illegible when filed}$$

Therefore, in order to correlate micro- and macroscopic simulation, microscopicfeature-related physical parameters like porosity, tortuosity, effective conductivity, effective diffusivity, reaction rate and open-circuit potential need to be obtained from the microscopic simulation of the 2D electrodes and 3D electrodes with fiber network backbone. In specific, the parameters are shown in following Table:

| Parameter | Value |
|---|---|
| Maximum concentration in negative electrode | 26390 |
| [mol · m−3] | |
| Anode electrode conductivity [S/m] | 400 |
| Anode electrode diffusivity [m² s⁻¹] | 2e−13 |
| Active material particle radium [m] | 5.84e−6 |
| Electrolyte conductivity [S/m] | 1.1 |
| Initial concentration in electrolyte [mol · m−3] | 1200 |
| Cation transfer number | 0.399 |
| Electrode porosity | 0.46 |
| Bruggman coefficient | 1.85 |
| Separator porosity | 0.763 |
| Separator Bruggman coefficient | 1.5 |

Then, a parametric study of electrolyte's diffusivity can be carried out with DFN model. FIG. 10b shows the half-cell anode charging simulation result (electrode's thickness: 85 μm) with various electrolyte's diffusivity, the overpotential on the anode side is significantly decreased when the net diffusion is increased.

In the following preparation of Example 1 and Comparative Example 1 is described.

Example 1 and Comparative Example 1 were prepared as described below. For both, Example 1 and Comparative Example 1, the active material used, contained 85 wt % graphite flakes (Sigma Aldrich), 10 wt % PVDF-HFP (polyvinylidenefluoride-co-hexafluoropropylene, Alfa Aesar) and 5 wt % Super P (Sigma Aldrich) as solid contents. The solid contents were dispersed in acetone in a 1:5 solid to liquid weight ratio. After vigorously stirring the slurry at 8000 RPM for 10 minutes with an IKA T 25 easy clean digital disperser, the slurry was coated onto the respective current collector material, i.e. three-dimensional network of copper fibers for Example 1 and 20 μm copper foil for Comparative Example 1.

### Example 1

Two disks of 14 mm diameter of a CuSi4 alloy (4 wt % Silicon, 96 wt % Copper) fiber network, having a thickness of 500 μm or of 1500 μm were punched out and used as electrodes in a CR2032 coin cell. The cell was assembled using a PTFE (Teflon) ring with an outer diameter of 16 mm, an inner diameter of 10 mm and a height of 1 mm as distance holder between both electrodes. After subsequently filling the cell volume with the electrolyte, the cell was assembled and tested after 2 hours wetting period.

### Comparative Example 1

the slurry was coated onto a 20 μm copper foil (PGChem) using an Automatic film applicator type BSVS1811/3 and an adjustable film applicator. A 14 mm diameter disc was punched out of the coated copper foil and the electrode was assembled in an argon-filled glovebox. As separator, a 16 mm disk of a glass fiber filter (Whatman Grade AH 630) and as electrolyte a 1 M LiPF6 1:1 EC/DMC (Ethylenecarbonate/Dimethylarbonate) was used. The counter electrode comprised entirely of 99.99 wt % pure Li. All components were subsequently assembled in a CR-2032 coin cell, which was wetted at least 2 hours prior to testing. The charging-discharging tests were performed with a constant charge/discharge program of 0.5 C after a forming period for 5 cycles at 0.1 C followed by a constant voltage step. The electrical impedance spectroscopy was performed from 100 mHz to 1 MHz with an amplitude of 40 mV at a voltage of 0.8 V for the half-cell configuration.

Electrochemical impedance spectroscopy (EIS) measurements on symmetrical cells were performed with an amplitude of 40 mV from 1 mHz to 1 MHz at a voltage of 0 V.

### REFERENCES

1. Brandt, K. Historical development of secondary lithium batteries. Solid State Ionics 69, 173-183 (1994).
2. Agubra, V. & Fergus, J. Lithium Ion Battery Anode Aging Mechanisms. Materials 6, 1310-1325 (2013).
3. Du, Z., Wood, D. L., Daniel, C., Kalnaus, S. & Li, J. Understanding limiting factors in thick electrode performance as applied to high energy density Li-ion batteries. J Appl Electrochem 47, 405-415 (2017).
4. Zheng, H., Li, J., Song, X., Liu, G. & Battaglia, V. S. A comprehensive understanding of electrode thickness effects on the electrochemical performances of Li-ion battery cathodes. Electrochimica Acta 71, 258-265 (2012).
5. Kawaguchi, T., Nakamura, H. & Watano, S. Dry coating of electrode particle with model particle of sulfide solid electrolytes for all-solid-state secondary battery. Powder Technology 323, 581-587 (2018).
6. Park, D.-W., Canas, N. A., Wagner, N. & Friedrich, K. A. Novel solvent-free direct coating process for battery electrodes and their electrochemical performance. Journal of Power Sources 306, 758-763 (2016).
7. Zheng, L., Bennett, J. C. & Obrovac, M. N. All-Dry Synthesis of Single Crystal NMC Cathode Materials for Li-lon Batteries. J. Electrochem. Soc. 167, 130536 (2020).
8. Kato, T. et al. Effects of sintering temperature on interfacial structure and interfacial resistance for all-solid-state rechargeable lithium batteries. Journal of Power Sources 325, 584-590 (2016).
9. Lee, S. C. et al. Binder-assisted electrostatic spray deposition of LiCoO2 and graphite films on coplanar interdigitated electrodes for flexible/wearable lithium-ion batteries. Journal of Power Sources 472, 228573 (2020).
10. Sun, H. et al. Hierarchical 3D electrodes for electrochemical energy storage. Nature Reviews Materials 4, 45-60 (2019).
11. Lain, M. J., Brandon, J. & Kendrick, E. Design Strategies for High Power vs. High Energy Lithium Ion Cells. Batteries 5, 64 (2019).
12. Gao, H. et al. Revealing the Rate-Limiting Li-lon Diffusion Pathway in Ultrathick Electrodes for Li-lon Batteries. J. Phys. Chem. Lett. 9, 5100-5104 (2018).
13. Zhang, X. et al. Multiscale Understanding and Architecture Design of High Energy/Power Lithium-Ion Battery Electrodes. Advanced Energy Materials 11, 2000808 (2021).
14. Shi, Y., Zhang, J., Pan, L., Shi, Y. & Yu, G. Energy gels: A bio-inspired material platform for advanced energy applications. Nano Today 11, 738-762 (2016).
15. Ju, Z. et al. Understanding Thickness-Dependent Transport Kinetics in NanosheetBased Battery Electrodes. Chem. Mater. 32, 1684-1692 (2020).
16. Jahnke, T. et al. Highly Porous Free-Standing rGO/SnO2 Pseudocapacitive Cathodes for High-Rate and Long-Cycling Al-Ion Batteries. Nanomaterials 10, 2024 (2020).
17. Raafat, L. et al. Shape-Conformable, Eco-Friendly Cellulose Aerogels as High-Performance Battery Separators. ACS Appl. Energy Mater. 4, 763-774 (2021).
18. Abe, T., Fukuda, H., Iriyama, Y. & Ogumi, Z. Solvated Li-lon Transfer at Interface Between Graphite and Electrolyte. J. Electrochem. Soc. 151, A1120 (2004).
19. Jow, T. R., Delp, S. A., Allen, J. L., Jones, J.-P. & Smart, M. C. Factors Limiting Li+ Charge Transfer Kinetics in Li-lon Batteries. J. Electrochem. Soc. 165, A361 (2018).
20. Vlad, A., Singh, N., Galande, C. & Ajayan, P. M. Design Considerations for Unconventional Electrochemical Energy Storage Architectures. Advanced Energy Materials 5, 1402115 (2015).
21. Deng, F. & Zheng, Q.-S. An analytical model of effective electrical conductivity of carbon nanotube composites. Appl. Phys. Lett. 92, 071902 (2008).
22. Miao, M. Electrical conductivity of pure carbon nanotube yarns. Carbon 49, 3755-3761 (2011).
23. Troltzsch, U., Kanoun, O. & Trankler, H.-R. Characterizing aging effects of lithium ion batteries by impedance spectroscopy. Electrochimica Acta 51, 1664-1672 (2006).
24. Hayamizu, K. Temperature Dependence of Self-Diffusion Coefficients of Ions and Solvents in Ethylene Carbonate, Propylene Carbonate, and Diethyl Carbonate Single Solutions and Ethylene Carbonate+Diethyl Carbonate Binary Solutions of LiPF6 Studied by NMR. J. Chem. Eng. Data 57, 2012-2017 (2012).
25. Bairav S. Vishnugopi, Feng Hao, Ankit Verma and Partha P. Mukherjee Surface diffusion manifestation in electrodeposition of metal anodes Phys. Chem. Chem. Phys., 2020, 22, 11286
26. Rico Rupp, Bart Caerts, Andre Vantomme, Jan Fransaer, and Alexandru Vlad, Lithium Diffusion in Copper The Journal of Physical Chemistry Letters 2019 10 (17), 5206-5210 (2019)

1-20. (canceled)

21. Electrode for a mono- or multivalent ion battery, comprising
a three-dimensional network of metal fibers, wherein the metal fibers are directly in contact to one another, and an active material, wherein
the network of metal fibers has a thickness in the range of 200 μm to 5 mm.

22. Electrode according to claim 21,
wherein the thickness of the three-dimensional network of metal fibers is in a range of greater than 500 μm.

23. Electrode according to claim 21,
wherein the electric conductivity of the network of metal fibers is equal to or greater than 1×10⁵ S/m.

24. Electrode according to claim 21,
wherein the volume fraction of metal fibers in the three-dimensional network of metal fibers is equal to or greater than 0.075 vol %.

25. Electrode according to claim 21,
wherein the porosity of the three-dimensional network is in the range of 90 vol % to 99.5 vol %.

26. Electrode according to claim 21,
wherein the metallic fibers have a width of 100 μm or less and a thickness of 50 μm or less.

27. Electrode according to claim 21,
wherein the spatial orientation of the metal fibers is unordered.

28. Electrode according to claim 21,
wherein the spatial orientation of the metal fibers is at least partially ordered.

29. Electrode according to claim 21,
wherein the density of the points of contact is in a range of 1 mm⁻³ to 5000 mm⁻³.

30. Electrode according to claim 21,
wherein the metal fibers are directly sintered to one another at points of contact between the metal fibers.

31. Electrode according to claim 21,
wherein the metal fibers contain at least one of copper, silver, gold, nickel, palladium, platinum, cobalt, iron, chromium, vanadium, titanium, aluminum, silicon, lithium, manganese, boron, combinations of the foregoing and alloys containing one or more of the foregoing.

32. Electrode according to claim 21,
wherein the metal fibers consist of copper or a copper alloy.

33. Electrode according to claim 21,
wherein the metal fibers consist of aluminum or an aluminum alloy.

34. A battery, comprising an electrode, the electrode comprising a three-dimensional network of metal fibers, wherein the metal fibers are directly in contact to one another, and an active material, wherein
the network of metal fibers has a thickness in the range of 200 μm to 5 mm.

35. The battery according to claim 34,
wherein the battery is a lithium ion battery, a sodium ion battery, a calcium ion battery, potassium ion battery, an aluminum ion battery, a zinc ion battery, and/or a dual ion battery.

36. The battery according to claim 34,
wherein the metal fibers consist of copper or a copper alloy.

37. The battery according to claim 34,
wherein the metal fibers consist of aluminum or an aluminum alloy.

38. An electric machine, the electric machine comprising a battery, the battery comprising an electrode comprising a three-dimensional network of metal fibers, wherein the metal fibers are directly in contact to one another, and an active material, wherein the network of metal fibers has a thickness in the range of 200 μm to 5 mm.

39. The electric machine according to claim 38, wherein the battery provides power to a circuit of the electric machine.

40. The electric machine according to claim 38, wherein the electric machine is an electric vehicle.
